(19) United States
(12) Patent Application Publication
(10) Pub. No.: US 2020/0394860 A1
(43) Pub. Date: Dec. 17, 2020

(54) Depositing and Taking System

(71) Applicant: Jao Ching Lin, Taipei City (TW)

(72) Inventor: Jao Ching Lin, Taipei City (TW)

(21) Appl. No.: 16/895,116

(22) Filed: Jun. 8, 2020

(30) Foreign Application Priority Data
Jun. 12, 2019 (TW) 108120314

(51) Int. Cl. G07C 9/00; G07C 9/22; G06K 7/14; H04W 4/12; H04L 12/58

(52) U.S. Cl. CPC G07C 9/00912; G07C 9/00182; G07C 9/22; G07C 2009/00769; H04W 4/12; H04L 51/04; G07C 2009/00246; G06K 7/1417

(57) ABSTRACT

A depositing and taking system includes a box with an electronic lock functional as a locking system for the box. A deliveryman mobile device is configured to transmit a signal through a wireless communication. By providing Identification information, the deliveryman mobile device requests and obtains a one time-used electronic key. The deliveryman mobile device could have the electronic lock unlocking through the one time-used electronic key and an object could be deposited in the box. The user of the user mobile device could unlock the electronic lock by using the electronic key and obtain the deposited objects. Hence, the present invention allows the user safely securing the deposited object in the box and preventing the object from stolen or the troublesome caused by that object being unable to be deposited.

### FIELD OF INVENTION

The present invention is generally related to a depositing and taking system, more particularly to an electronic depositing and taking system by a transmission of an electronic access.

The present invention has been developed primarily to be a depositing and taking system for electronic mailbox with transmitting an electronic key and will be described hereinafter with reference to this application. However, it will be appreciated that this invention is not intended to limit to this particular filed of use.

### BACKGROUND OF THE INVENTION

Online shopping becomes more and more popular in recent year due to prosperous development of e-commerce industry. Customer could casually place their orders online at home and waits for products being delivered to them. To provide a more friendly and convenient service to the customer, shipping company normally is able to deliver the products at a certain time according to the desire of the customer. However, it is still possible that the product can't arrive at right time for the customer to receive. Deliverymen of the shipping company might need to contact the customer and reschedule another time for delivery.

Some customers could choose an alternative approach for products retrieval in a convenient store nearby. This shipping route involves with the co-working of the shipping company and the convenient store. This alternative solution will take more time for the customer to receive their product than usual. It also brings some troublesome to the customers for going to the convenient store retrieving their products. Hence, it is eager to have a depositing and taking system that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve shortcomings and inconvenience of the products delivering online as mentioned above, the present invention provides an electronic depositing and taking system in which an electronic access is provided for express delivery operators to unlock a mailbox, so that the deliveryman is able to deposit the customers products or packaging in their mailbox. The present invention provides a more convenient and safer way for the customers receiving their online ordered product.

To achieve the exemplary purpose as described above, the present invention is required. The present invention is a depositing and taking system having a box with an electronic lock; a box with an electronic lock; a deliveryman mobile device sends a request including an identification information to a user mobile device; the user mobile device responds with a one time-used electronic key to the deliveryman mobile device after verification; and the one time-used electronic key is able to unlock the electronic lock for one time.

In accordance, the electronic key is stored in the user mobile device.

In accordance, a sign-in stamp is placed in the mailbox.

In accordance, a bar code is displayed in the mailbox. The deliveryman mobile device scans the bar code in the mailbox after unlocking the mailbox by the single-use electronic key and reports a receipt message to a remote depositor server. The remote depositor server sends an alert message to the user mobile device.

In accordance, the deliveryman mobile device is installed in a depositor application. The depositor application is executed to communicate with the user mobile device. The depositor application is executed to scan the bar code in the mailbox.

In accordance, the request from the deliveryman mobile device sending to the user mobile device is a text message or an email, and the one time-used electronic key is obtained by the user mobile device's response in text message or email. The alert message sent from the depositor server to the user mobile device is in text message or email form.

In accordance, the deliveryman mobile device executes the depositor application to communicate with the user mobile device through an internet network, and the alert message sent from the depositor server to the user mobile device is displayed on the depositor application of the user mobile device.

In accordance, the identification information is a video, a photo or an ID number.

When using the present invention, the deliveryman for delivering mails or packages could firstly send a request through wireless communication including the identification information to the user mobile device. The user of the mobile device can identify the deliveryman from the identification information. The user could respond with a one time-used electronic key through the user mobile device. The deliveryman can thus unlock the electronic lock to open the mailbox by the one time-used electronic key for depositing mails, products or packages in the mailbox and lock it up after the deposit. The user is able to collect the deposited items by unlocking the electronic lock with a key card, a buckle or other carriers stored with the electronic key.

One of the exemplary purposes of the present invention is that by responding the deliveryman's mobile device's request with a one time-used electronic key, the user could remotely allow the deliveryman to deposit the objects in the mailbox. The mailbox can then be unlocked again for the user to pick up. The user is no longer need to stay at home for the delivery man or to reschedule another pick-up time with the deliveryman. The products they ordered could directly deliver to their home without going to the convenient stores for picking up their products. The present invention improves the convenience of products delivery for online shopping. Moreover, the present invention also applies to the packages sent by other people (e.g., friends).

Besides the application of depositing the products or packages, the present invention also applies to a user to send packages to someone else. User could put items to be send (or delivered) in the mailbox attached with mailing information like recipients and address. After contacting the deliveryman or placing a shipping order to the shipping company, the deliveryman obtains a one time-used electronic key from the user. The deliveryman can then schedule for retrieving the stored items in the mailbox and delivery it to the recipients. User will no longer need to go to the post office for mailing packages in a traditional way.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve one or more of the above objectives can be best understood by referring to the following detailed description of the preferred embodiments and the accompanying drawings.

FIG. 1 is an illustrative view of a preferable embodiment in accordance to the present invention;

FIG. 2 is an illustrative view of embodying a preferable embodiment in accordance to the present invention; and

FIG. 3 is an illustrative view of a preferable embodiment of embodying receipting with a stamp in accordance to the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for the purposes of explanation, numerous specific details are set forth in order to provide a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

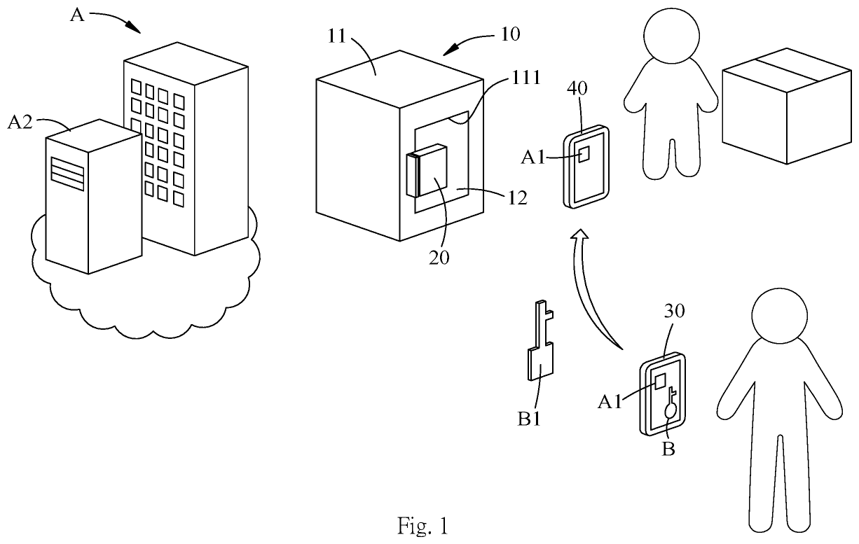

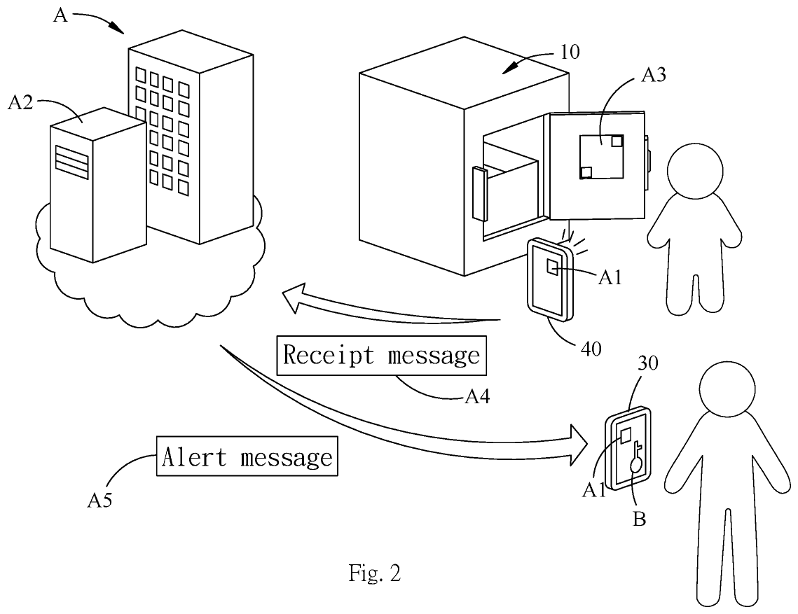

References are made to FIGS. 1 and 2, in which an exemplary embodiment of the present invention is demonstrated. In FIGS. 1 and 2, a depositing and taking system for an electronic mailbox is provided. The system includes a mailbox 10, an electronic lock 20, a user mobile device 30 and a deliveryman mobile device 40. In the exemplary embodiment, the electronic lock 20 is provided by the delivery company A, a depositor application A1 is respectively installed on the user mobile device 30 and the deliveryman mobile device 40. The delivery company A sets up a depositor server A2 among an internet network, and the owner of the mailbox 20 is also the user of the electronic lock 20, who relies on the delivery company's A service to retrieve mails or packages. The depositor company A has users' personal information stored in the depositor server A. Personal information includes, but not limited to, users' phone number or email address.

The mailbox 10 includes a box 11, and an opening 111 is formed on the box 111. A rim of the opening 111 is pivoted with a trapdoor 12. The trapdoor 12 is configured to have the opening 111 to be opened or closed. A bar code A3 is showed or displayed on an inner side of the trapdoor 12. The bar code A3 could be displayed on the trapdoor 12 by sticking or printing on the inner side of the trapdoor 12, and is assigned by the depositor server A2. The bar code A3 includes an information for connecting with the depositor server A2.

The electronic lock 20 is combined with the mailbox 10 to lock the trapdoor 12 on the mailbox 10. The electronic lock 20 can be unlocked by an electronic access, such as an electronic key B received through a near field communication (NFC) or bluetooth. The electronic key B can be an electronic file carried by the user mobile device 30. The electronic key B could also be carried by other common format like key card or buckle.

One preferred embodiment of the user mobile device 30 could be a mobile phone or a smart phone. The electronic key B is installed or carried by the user mobile device 30. By executing the depositor application Al, a one time-used electronic key B1 can be generated to open the electronic lock 20 at a single time. The depositor application A1 in the user mobile device 30 can provide the one time-used electronic key B1 to the deliveryman mobile device 40 remotely through the depositor application A1 upon a request from the deliveryman mobile device 40.

The deliveryman mobile device 40 is exemplified as a smart phone in the present embodiment, for that that depositor application A1 can be installed on it. Through wireless communication, the deliveryman mobile device 40 sends a request to the user mobile device 30. The request includes identification information for the user to identify that the request was sent from the deliveryman. The identification information may be but not limited to a video, a photo or an ID number. The user mobile device 30 responds with the one time-used electronic key B1. The deliveryman can thus unlock the electronic lock 20 to open the mailbox 10 through the one time-used electronic key B1, then the deliveryman can deposit mails, products or packages in the mailbox 10 and lock the trapdoor 12 again after complete the action.

After the deliveryman deposited the mails or packages in the mailbox 10, the deliveryman may hold the deliveryman mobile device 40 to scan the bar code A3 by the depositor server A2. The deliveryman mobile device 40 then receives an information for contacting the depositor server A2 and reports a receipt message A4 to the depositor server A2. After the depositor server A2 receives the receipt message A4, the depositor server A2 then sends an alert message A5 to the corresponding remote user mobile device 30. The alert message A5 may be displayed on the depositor application A1 of the user mobile device 30 to remind the user that the mails, the products or the packages have been deposited in the mailbox 10. The depositor application A1 receives the alert message A5 could be seen or used as a signing confirmation from the user indicating that the user has safely received the mails, the products or the packages.

Another embodiment of the present invention is that the electronic key 20 may be provided other from the depositor company A, and the depositor application A1 is not necessary to be installed in the user mobile device 30 and deliveryman mobile device 40. In this situation, if the deliveryman intends to deposit objects in the mailbox 10, the deliveryman should send a request through the deliveryman user device 40 including the above-mentioned identification information to the user mobile device 30. The user could respond to the request by sending a one time-used electronic key B1 generated by other applications to the remote deliveryman mobile device 40. The deliveryman can then open the mailbox 10 with the one time-used electronic key B1 and deposit objects in the mailbox 10.

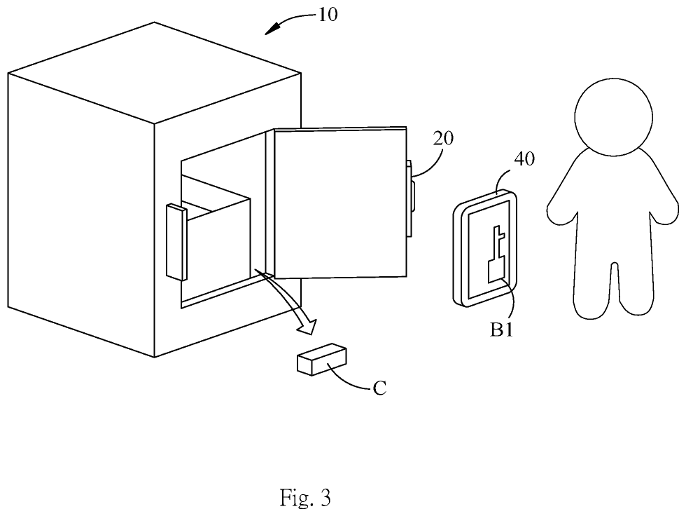

The user signs for the confirmation of the delivery could be the way as described above. As shown in FIG. 3, the user could also sign for the delivery by embodying receipting with a stamp (or, sign for with a stamp). In addition to that implementation, an alternative can be carried out by placing a sign-in stamp C in the mailbox 10. The stamp C may be, for example, the user's private stamp. In this alternative solution, after the deliveryman successfully deposits the objects in the mailbox 10, the deliveryman may stamp on a sign-in book to meet the equivalent outcome as the bar code scanning.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. An depositing and taking system comprising:
a box with an electronic lock;
the electronic lock can be unlocked by an electronic access received through wire or wireless communication;
a deliveryman mobile device sends a request including an identification information to a user mobile device;
the user mobile device responds with a one time-used electronic key to the deliveryman mobile device after verification; and
the one time-used electronic key is able to unlock the electronic lock for one time.

2. The system as claimed in claim 1, wherein the electronic key is stored in the user mobile device.

3. The system as claimed in claim 1, wherein a sign-in stamp is placed in the mailbox.

4. The system as claimed in claim 1, wherein:
a bar code is displayed in the mailbox;
the deliveryman mobile device scans the bar code in the mailbox after unlocking the mailbox by the single-use electronic key and reports a receipt message to a remote depositor server; and
the remote depositor server sends an alert message to the user mobile device.

5. The system as claimed in claim 4, wherein:
the deliveryman mobile device is installed in a depositor application;
the depositor application is executed to communicate with the user mobile device; and
the depositor application is executed to scan the bar code in the mailbox.

6. The system as claimed in claim 1, wherein:
the request from the deliveryman mobile device sending to the user mobile device is a text message or an email, and the one time-used electronic key is obtained by the user mobile device's response in text message or email; and
the alert message sent from the depositor server to the user mobile device is in text message or email form.

7. The system as claimed in claim 2, wherein:
the request from the deliveryman mobile device sending to the user mobile device is a text message or an email, and the one time-used electronic key is obtained by the user mobile device's response in text message or email; and
the alert message sent from the depositor server to the user mobile device is in text message or email form.

8. The system as claimed in claim 3, wherein:
the request from the deliveryman mobile device sending to the user mobile device is a text message or an email, and the one time-used electronic key is obtained by the user mobile device's response in text message or email; and
the alert message sent from the depositor server to the user mobile device is in text message or email form.

9. The system as claimed in claim 4, wherein:
the request from the deliveryman mobile device sending to the user mobile device is a text message or an email, and the one time-used electronic key is obtained by the user mobile device's response in text message or email; and
the alert message sent from the depositor server to the user mobile device is in text message or email form.

10. The system as claimed in claim 5, wherein:
the request from the deliveryman mobile device sending to the user mobile device is a text message or an email, and the one time-used electronic key is obtained by the user mobile device's response in text message or email; and
the alert message sent from the depositor server to the user mobile device is in text message or email form.

11. The system as claimed in claim 5, wherein the deliveryman mobile device executes the depositor application to communicate with the user mobile device through an internet network, and the alert message sent from the depositor server to the user mobile device is displayed on the depositor application of the user mobile device.

12. The system as claimed in claim 1, wherein the identification information includes a video, a photo or an ID number.

13. The system as claimed in claim 2, wherein the identification information includes a video, a photo or an ID number.

14. The system as claimed in claim 3, wherein the identification information includes a video, a photo or an ID number.

15. The system as claimed in claim 4, wherein the identification information includes a video, a photo or an ID number.

16. The system as claimed in claim 5, wherein the identification information includes a video, a photo or an ID number.
